(19) United States
(12) Patent Application Publication
(10) Pub. No.: US 2007/0288372 A1
(43) Pub. Date: Dec. 13, 2007

(54) METHOD AND SYSTEM FOR AWARDING REBATES BASED ON CREDIT CARD USAGE TO CREDIT CARD HOLDERS

(75) Inventors: Sheryl Behar, Hewlett, NY (US); Carol Lewbell-Gray, New York, NY (US); Cheryl Cunha, Cambria Heights, NY (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: CITIBANK, N.A., New York, NY (US)

(21) Appl. No.: 11/837,956

(22) Filed: Aug. 13, 2007

Related U.S. Application Data
(62) Division of application No. 09/469,993, filed on Dec. 22, 1999.
(60) Provisional application No. 60/113,286, filed on Dec. 22, 1998.

(51) Int. Cl. G06Q 40/00; G06Q 30/00

(52) U.S. Cl. 705/41

(57) ABSTRACT

A method and system for awarding rebates based on credit card usage to a consumer credit card holder is provided. A rebate tally is accrued based on a percentage of eligible purchases made by the consumer card holder. The rebate is earned when the consumer card holder makes a qualifying purchase, which may be, for example, an automobile sold by any manufacturer. The rebate program disclosed does not associate the rebate earned with any particular manufacturer. The rebate is paid directly by the credit card issuer to the credit card holder.

### CROSS-REFERENCE TO RELATED APPLICATIONS

This application claims the benefit of priority from U.S. Provisional Application Ser. No. 60/113,286, filed Dec. 22, 1998.

### BACKGROUND OF THE INVENTION

The present invention is directed to credit cards or bank cards and the like, and more particularly, to methods and systems for enhancing the value of a substantially conventional credit card to both the credit card holder or user of the card and to the bank, financial institution or other issuer of the card by providing rebates based on credit card usage to the credit card holder.

Credit cards are ubiquitous in today's society. Many consumers have more than one credit card and regularly use different credit cards to make their various purchases. Banks and financial institutions issue credit cards and service credit card accounts. The issuer may also make money by a per transaction fee or commission charged to retailers and other merchants when the retailer processes a credit card holder's purchase, and from finance charges accrued when the credit card holder incurs a revolving balance on that issuer's credit card.

Credit card issuers would prefer that any consumer card holder predominantly use that issuer's credit card in order to generate the largest number of sales fees and revenue. Therefore, credit card issuers may offer incentives to card holders who use that issuer's card. Often the incentives are accumulated when the card holder uses the credit card. This benefits the card issuer because, with the sales, comes the opportunity for the card issuer to generate revenue.

Banks and other financial institutions can also offer credit cards from which the credit card holder receives a particular benefit every time a transaction, using that card, is made. For example, the user benefit may be an entry into a sweepstakes, a certain amount of frequent flyer miles, or a discount voucher good towards a vacation, merchandise, lottery tickets or a gift. These benefits are also promoted by the banks or card issuing organization as an incentive for the credit card holder to use their credit card. However, because card holders can use these programs to accumulate the benefit merely by making purchases, the issuer will likely have to process increasing numbers of transactions without a corresponding increase in interest charges on revolving balances or revenues.

Increasingly, credit cards are being issued by banks and financial institutions in association with other commercial companies or businesses which themselves offer goods and/or services. This phenomenon, known as co-branding, provides a credit card that often carries the name of the commercial company along with the issuer's name. The commercial company often provides the credit card holder certain benefits which are typically related to the goods or services provided by that commercial company. For example, the General Motors MasterCard or Visa credit card offers credit card holders up to a 5% rebate on their card purchases good towards the purchases or lease of a new General Motors automobile. The amount of the total rebate available is based on the amount of charges placed on the card holder's General Motors MasterCard or Visa card. Generally, on co-branded cards, the rebate is accrued at a rate of from 1% up to 5% of each purchase by the credit card holder.

Another widespread example of co-branded credit cards are the airline partnered credit cards which award the credit card holder frequent flyer mileage based on the accrued card charges.

Co-branded credit card rebates are usually applied to a specific commercial partner's goods or services. The credit card holder should anticipate which products or services it will use, and sometimes has to plan the purchase, for example, in the case of an automobile, years in advance to attempt to receive the maximum available benefit. Therefore, it would be advantageous to provide a benefit to card holders that can be applied to the goods and services of a broad selection of commercial companies within a category.

Conventional manufacturer rebate programs essentially offer a refund from a manufacturer to the consumer good toward the purchase of a specified product or service, or in some cases, cash. They generally require the consumer to submit a rebate form as well as a proof of purchase of the product to the manufacturer, and the manufacturer to then send the rebate amount to the consumer. These types of rebate programs may involve the inconvenience and inefficiency of filling out the form and remembering to mail it to the manufacturer, as well as the delay in receiving payment from the manufacturer, which must process the form, validate the purchase and mail out the check.

With all the various benefit and incentive programs available from credit card issuers, consumers may have difficulty choosing between the different credit cards that they hold when deciding to make a purchase. For example, should the credit card holder choose a charge card which accumulates credit towards the purchase of gas, or a card which provides frequent flyer miles, or a card which provides some other benefit to the credit card holder? Also, since incentives and benefit programs which are sponsored by a particular commercial company require that the credit card holder redeem rebates for goods or services from that sponsoring merchant, it limits the choices the consumer has when redeeming rebates. For example, if they are accumulating benefits on a gas company sponsored credit card, in order to take advantage of that benefit, they must purchase gasoline at the sponsoring company's gas stations, or if they are accumulating frequent flyer miles with one airline, they are constrained to use that airline or its frequent flyer program partners when planning a trip if they are to take advantage of the benefit. Because of the limits on redemption, the appeal of the card may be less than universal.

It is thus seen that an opportunity exists for a credit card benefit program which provides a valuable perceived benefit to the card holder, without sacrificing or inhibiting the card holder's ability to take advantage of the benefit, and which is cost effective and efficient to maintain by the credit card issuer.

### SUMMARY OF THE INVENTION

Generally speaking, a method and system for providing rebates based on purchases using a credit card, bank card, smart card, ATM card, debit card and the like is provided. The system allows a card holder to earn a percentage of their accumulated purchases as a rebate amount. The rebate amount is accrued or earned by the card holder upon making a qualifying purchase of goods or services. The qualifying purchase may be of the goods and services of any commercial company within a category providing those goods and services. In a preferred embodiment, rebates are only earned based on the purchases made by the card holder with the credit card. That is, in the preferred embodiment, rebates are typically not earned on cash advances and transfers of credit to the credit card account. Alternative embodiments permit rebates to be earned on cash advances and transfers of credit balances to the credit card account and the like.

In accordance with the invention, a bank or other financial institution offers a credit card or the like to a consumer. A percentage of the qualifying purchases made with the card holder are accrued to the card holder as a rebate. In a preferred embodiment, the rebate is paid to the card holder when the card holder purchases or leases a new car from any manufacturer. In this preferred embodiment of the invention, a card holder purchases or leases a new car from a manufacturer in the United States and then sends proof of purchase or lease to the bank (for example the sales receipt, and a document indicating change of title of the automobile). The bank validates the purchase or lease by, for example, reviewing the authenticity of the documentation, and upon validation, sends a check equal to the amount of the “earned rebate” back to the card holder. Alternatively, the earned rebate can be applied to the card holder's credit card balance. Alternative embodiments allow rebates on purchases or leases of new or used cars from any car dealer, and the like.

The invention is not limited to new automobiles and may be applied to the purchases of any goods and services within a given category which can be purchased from any vendor. For example, the rebate program of the invention can advantageously be used for purchasing major appliances, electronic goods, and the like. In addition, it may be desirable for the card holder to provide two forms of proof and, furthermore, at least one of the proofs of purchase can even be provided directly from the manufacturer or retailer selling the goods. Finally, is not necessary for the card issuer to validate the program purchases at all, although this is clearly desirable to prevent fraud and the like.

Another preferred embodiment of the credit card rebate program of the invention allows users to earn rebates on the purchase or lease of any new vehicle, regardless of make or model. In this preferred embodiment, card holders are offered 2% rebate on eligible purchases made, up to five hundred dollars in rebates earned per year, with a maximum of $1500 good towards any one vehicle that is purchased or leased. The car purchased or leased is not associated with any specific automobile manufacturer, so the credit card rebates earned can be applied no matter which manufacturer of automobile the card holder chooses to purchase or lease the car from.

In this preferred embodiment of the method and system of the invention as disclosed, a card holder can negotiate the best price possible with the auto dealer, and can include any special sales, promotions or other rebates that are available, and complete the purchase. Once the purchase is made, the card holder then returns a completed redemption form along with a proof of purchase to the credit card issuer. A check for the rebate amount is then forwarded to the card holder directly from the credit card issuer, typically within three weeks, for example. Alternatively, the rebate amount may be applied to the card holder's credit card balance.

The credit card rebate method and system of this preferred embodiment of the invention allows the card holder to decide on their choice of vehicle at the time of purchase, and, given that the rebates can be used along with any other special program at the dealer, the card holder can obtain the vehicle at the best possible price they can negotiate.

In another preferred embodiment of the method and system of the invention, card holders may transfer rebates earned to certain other authorized member of the program, typically a qualified household member who shares the same address.

It is accordingly an object of the invention to provide a system and method for enhancing the value of a credit card to a credit card holder and encouraging increased use of the credit card as a payment device by awarding rebates based on eligible purchases.

Another object of the invention is to provide a system and method for awarding rebates which can be redeemed by making the purchase of a product or service irrespective of the manufacturer or provider of the product or service within a category.

A further object of the invention is to provide a credit card rebate program in which the rebate is paid by the credit card issuer, rather than the manufacturer.

Still another object of invention is to provide a method and system for efficiently keeping track of a rebate tally and paying the rebate when the card holder makes a qualifying purchase.

Still other objects and advantages of the invention will in part be obvious and will in part be apparent from the specifications and drawings herein.

The invention accordingly comprises the several steps and the relation of one or more of such steps with respect to each of the others, and the system embodies features of construction, combinations of elements and arrangement of parts which are adapted to effect such steps, all as exemplified in the following detailed disclosure.

### BRIEF DESCRIPTION OF THE DRAWINGS

For a fuller understanding of the invention, reference is had to the following description taken in connection with the accompanying drawings, in which:

FIG. 1 depicts a schematic representation in flow chart form of the steps involved in processing a purchase in accordance with the rebate method and system of the invention;

FIG. 2A depicts a schematic representation in flow chart form of the initial steps involved in processing a rebate in accordance with the rebate method and system of the invention; and

FIG. 2B depicts a schematic representation in flow chart form of the additional steps involved in processing a rebate in accordance with rebate method and system of the invention.

### DETAILED DESCRIPTION OF THE PREFERRED EMBODIMENT

The present invention is directed to credit cards or bank cards and the like and more particularly to methods for enhancing the value of a substantially conventional credit card by giving the card holder a rebate on eligible purchases good toward the purchase of qualifying goods or services and the like.

Credit cards or charge cards allow card holders to pay for services and/or merchandise without using cash. Credit cards are generally issued by a bank or other financial institution and provide a mechanism by which a user can receive a temporary loan from the bank for the purpose of paying for the purchase. The user may thereafter either pay the outstanding balance or, as a matter of choice, defer the balance for later payment with accompanying interest or finance charges for the period during which payment of the debt is deferred.

One advantage of the credit card rebate program disclosed is that it is not tied to any particular manufacturer, and instead, the card holder can select the product or service to which a rebate will be applied from any provider. For example, in a preferred embodiment, the rebate program is applied to an automobile purchase or lease. Therefore, the card holder can negotiate the best possible price with a car dealer, including any special sales, promotions or other rebates that are available, and complete the purchase. Once the purchase is made, the card holder then returns a completed redemption form, along with a proof of purchase to the bank. A check for the rebate amount will be forwarded to the card holder directly from the bank or the rebate amount may be applied to the card holder's outstanding balance.

In a preferred embodiment, card holders can get a rebate on any new or used vehicle purchased or leased in the United States. This means that the card holder can decide on the choice of vehicle at the time of purchase, rather than locking in a rebate program for a particular manufacturer as with conventional rebate programs. Additionally, the rebates can be used along with any other rebate program the manufacturer may offer, and the card holder can therefore negotiate the best possible price.

Typically, a monthly statement from the credit card issuer for a credit card in accordance with this invention will include a rebate summary section displaying the card holder's current amount of rebate points, or rebate tally, available.

In an example of an embodiment of the rebate credit card, the card issuer offers card holders 2% rebates on eligible purchases made with the card, up to $500 in rebates per year, with a maximum of $1500 over a three year period for any one vehicle that is purchased or leased. The card is not associated with any specific automobile manufacturer, so the earned rebates can be applied to any vehicle when purchased or leased from any manufacturer. Furthermore, the rebate comes directly from the credit card issuer, and can be used in addition to any premiums or special programs offered by the manufacturer.

In the credit card rebate method and system of another embodiment of the invention, rebates may be redeemed regardless of the best price card holders negotiate with a dealer. This increases the savings for those card holders that also take advantage of special sales promotions at the car dealer. After purchasing or leasing the vehicle of their choice at the best price that can be negotiated, the card holder simply mails in a proof of purchase of the automobile, preferably including the VIN number. The issuer then validates the qualifying purchase and mails a check to the card holder, typically within three weeks, in the amount of the earned rebate. Alternatively, the earned rebate can be applied to the credit card holder's balance on the credit card.

From the consumer's point view, the rebate credit card of the invention provides all the benefits of an ordinary credit card during use. For example, when a consumer goes to a store to make a purchase and chooses to pay for its purchases by using the rebate credit card of the invention, the credit card is handed to the store clerk and the clerk processes a credit card receipt in the conventional manner.

From the retailer's point view, the rebate credit card of the invention is handled the same way as an ordinary credit card. For example, in processing the credit card receipt, the clerk transmits information about the purchase to their processing bank which transmits the transaction information to the credit card association (such as Visa or MasterCard) which then transfers the information to the bank which issued the card. The issuing bank then pays the store the amount on the credit card receipt (minus any transaction fee or commission) in the conventional manner, typically by applying a credit to the store's account at the processing bank. The credit card issuer then applies the amount of the purchase to the consumer's balance on the credit card and determines the rebate tally.

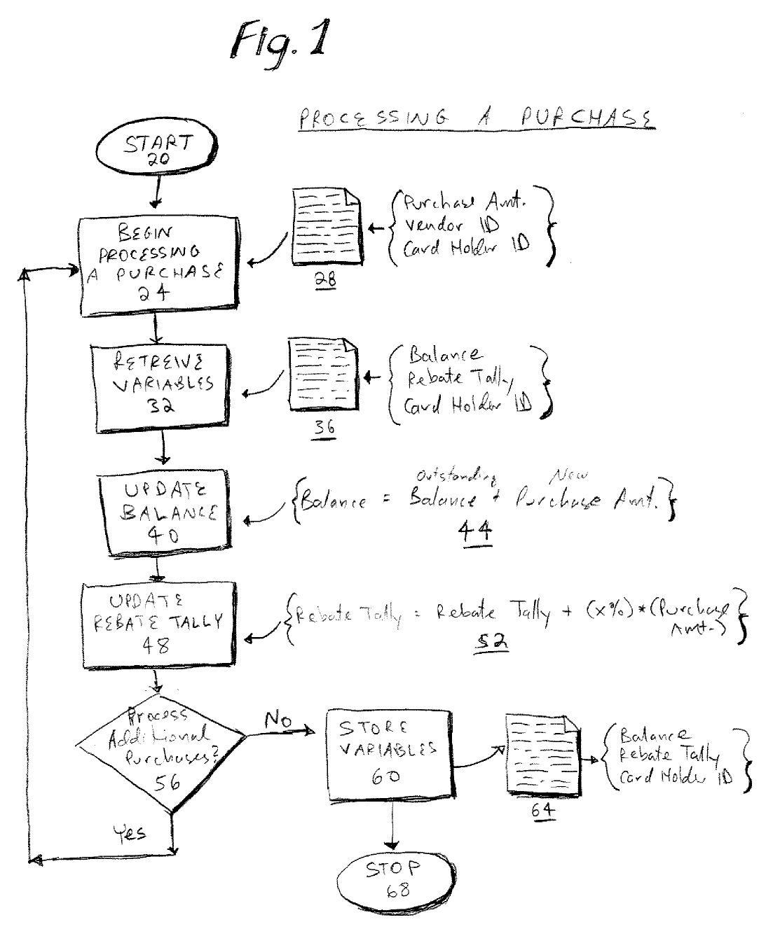

Referring now to the drawings, FIG. 1 depicts a schematic representation in flow chart form of the steps involved in the bank or other card issuer processing the consumer's purchase and tracking earned rebates in accordance with the invention. Processing the purchase begins at the start 20. The step of beginning to process a purchase 24 includes retrieving purchase data 28 from a storage medium. Typically, purchase data 28 is stored electronically or on magnetic medium readable by a computer. Purchase data 28 typically includes at least the purchase amount, the vendor ID, and the card holder ID. Purchase data 28 is received from the retail store which processed the card holder's credit card receipt and transmitted the information about the purchase to the bank. Typically, for example, such information is transmitted electronically by the store and stored electronically or on magnetic medium. Such information can also be transmitted physically (a paper receipt) and entered into electronic or magnetic storage by a key punch operator. Purchase data 28 may also include information identifying the products or services purchased, the time and date of the purchase, and the like.

Variables associated with the card holder are then retrieved at a step 32. The card holder variables 36 are typically stored electronically or on magnetic medium readable by a computer. Card holder variables 36 generally include at least the card holder's current balance, rebate tally (to be described further below) and card holder ID which matches the card holder ID from purchase data 28. Card holder variables 36 may also include such information necessary for preparing a monthly balance statement to the card holder, such as tracking each purchase for the month, any finance charges accrued, and the like.

The next steps can be done in either order, or can be done simultaneously. For the sake of this embodiment, the system of the invention first updates the balance 40. Updating balance 40 involves processing the mathematical formula “balance=outstanding balance+new purchase amount” 44. In this way, formula 44 maintains the variable balance as the sum of all purchase amounts.

The system of the invention updates the rebate tally 48. Updating rebate tally 48 involves processing the mathematical formula “rebate tally=rebate tally+(x %)*(purchase amount)” 52. In this way, formula 52 maintains the variable rebate tally as the sum of each individual rebate tally. Each individual rebate tally is calculated as a percentage of the card holder's eligible purchases, represented in formula 52 by x %. Typically, in the rebate system of the invention, the rebate percentage is between two percent and five percent. It should be understood that any percentage can be used. Additionally, the percentage used can be variable, and can, for example, increase or decrease after a certain amount of total purchases are made for a month. Additionally, by running certain promotions, the percentage used can increase for purchases made during a specific time period, such as the holiday season.

The system then determines if additional purchases need to be processed at a step 56. If additional purchases to need to be processed, processing repeats at the step of beginning to process a purchase 24. If additional purchases do not need to be processed, the system stores the variables 60 in electronic or magnetic medium readable by a computer. The stored variables 64 include the newly computed balance and rebate tally. The procedure for processing a purchase then stops at step 68.

When a card holder has accrued a rebate tally, that amount can be applied to qualifying purchases. Qualifying purchases may depend on the credit card program being run, and may for example include the purchase or lease of the new or used car. In this case, when the card holder purchases or leases a car, that card holder is entitled to receive an amount equivalent to the rebate tally, up to the maximum specified by the program terms.

Credit card programs in accordance with the invention can include rebates for the purchase of specific types of products, specific brands of products, or for purchases made at a particular retail outlet. Most preferably, the credit card programs in accordance with the invention allow a card holder to receive the rebate when purchasing a specific type of product in a particular category no matter the manufacturer. This adds perceived value to the credit card because the consumer can choose the brand of the product to be purchased at the time of the purchase, rather than being locked into the purchase of that kind of product from a specific manufacturer. Additionally, since the rebate is earned directly from the credit card issuer, rather than from the manufacturer or retailer, the credit card holder is free to negotiate the best deal it can, including any additional sales, bonuses or rebates that may be available.

The credit card rebate program thus described also adds value to the credit card issuer, because, not being associated with a particular manufacturer or retailer allows the credit card issuer to run additional incentive programs with any manufacturer or retailer. Additionally, unlike conventional credit card rebate programs, the credit card issuer is not seen as a partner with a particular sponsoring manufacturer, and therefore is free to make other business affiliations with any manufacturer interested.

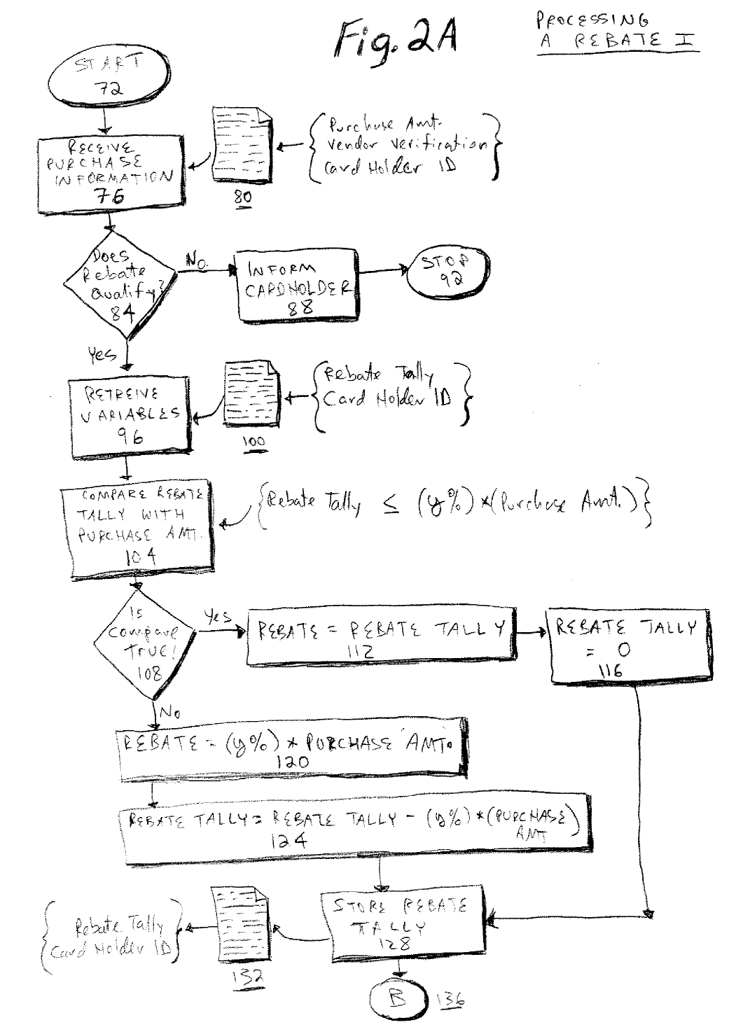

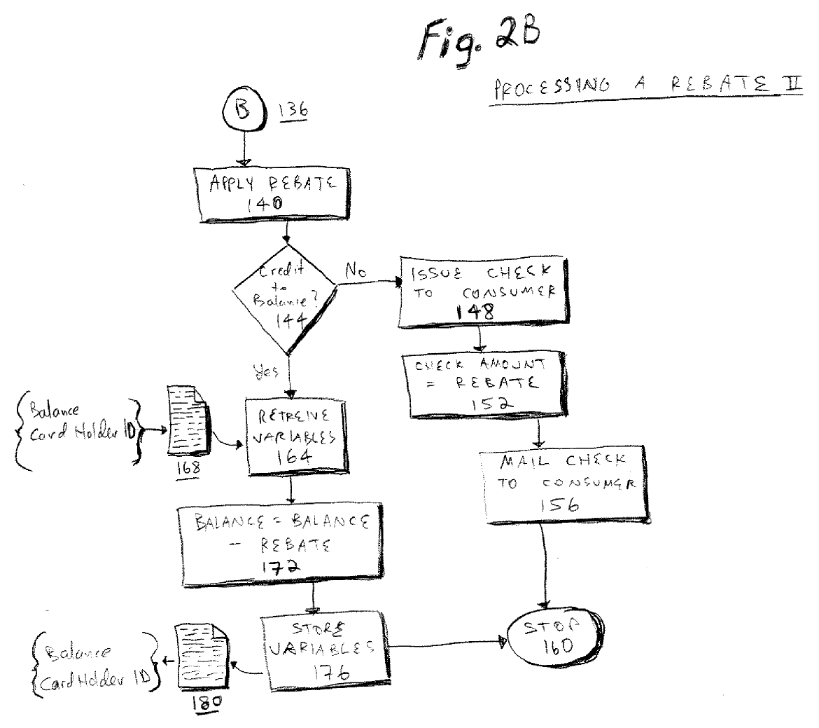

FIG. 2A depicts a schematic representation in flow chart form of the steps for processing a rebate. The steps begin at the start 72, and the system then receives purchase information 76. The purchase information 80 received includes the purchase amount, vendor verification information and the card holder ID. Vendor verification information will depend on the rebate program being run. For example, in the case of purchasing or leasing a new automobile, vendor verification may include the sales contract or lease along with the document indicating change of title for the automobile. In the case of, for example, major appliances or electronic goods, vendor verification may come in the form of a sales receipt and the completed warranty card or other authenticated document.

The system then determines if the rebate qualifies at a step 84. The system can check the received purchase information 80 and match the information against the credit card program policy. If the applied for rebate does not qualify, the system can inform the card holder at a step 88 of the reasons and then the system stops processing at a step 92. If, on the other hand, the check to see whether the rebate qualifies at step 84 is “yes”, the system proceeds to retrieve rebate variables at a step 96. The retrieved rebate variables 100 will include at least the card holder ID and rebate tally for that card holder.

The system then compares the rebate tally with the purchase amount 104. The comparison of the rebate tally with purchase amount at step 104 is accomplished by computing the mathematical formula “rebate tally=(y %)*(purchase amount)” in which y % represents the maximum percentage of the total purchase on which a rebate will be given. Typically, for example, no more than 1% up to 5% of the total purchase amount of the qualifying purchase will be earned by the card holder as a rebate. It should be understood that this amount can be fixed or can be variable, depending on the credit card program.

The system analyzes the results of the comparison at a step 108, and if it is “yes” (that is, the rebate tally is less than or equal to the maximum percentage of the purchase amount on which a rebate is given) the system assigns the rebate value equal to the rebate tally at step 112. The system also assigns the rebate tally equal to zero at a step 116 (since the entire rebate tally will be awarded to the card holder, the new rebate tally is zero). It should be understood that the steps of setting the rebate value equal to the rebate tally at step 112, and the step of setting rebate tally equal to zero at a step 116 can be performed simultaneously or in either order.

If the comparison at step 108 is “no” (that is, the current rebate tally is greater than the maximum amount of rebate available for that qualifying purchase) then the rebate is assigned to the maximum rebate available at a step 120, in accordance with mathematical formula “rebate=(y %)*(purchase amount)” in which y % represents the maximum percentage of the total purchase on which a rebate will be given.

Because the entire rebate tally is greater than the maximum rebate value to be given, a remaining rebate tally is calculated at a step 124 in accordance with the formula “rebate tally=rebate tally−(y %)*(purchase amount)” which yields the rebate tally remaining after the maximum amount is used in the qualifying purchase.

The system then stores the rebate tally and the card holder ID at a step 128. Rebate tally and card holder ID 132 is stored in preferably electronic or magnetic medium which is readable by a computer.

Therefore, as result of the comparison of the rebate tally with the purchase amount at step 104, the lesser of the rebate tally earned and the maximum rebate allowable is assigned to the rebate value earned by the card holder on this qualifying purchase.

The processing of the rebate is then continued, as indicated by B at 136, and as also shown in FIG. 2B. As shown in FIG. 2B, the system then applies the rebate to the card holder at a step 140. In accordance with the credit card rebate program, or with the card holder's wishes, a determination of whether to apply the rebate to the card holder's balance is performed at a step 144. If the rebate is not to be applied to the card holder's balance, a check is issued to the consumer at a step 148 in which the check amount is equal to the rebate value at a step 152. The check is mailed to the consumer at a step 156 and processing stops at a step 160.

If, however, the rebate is to be credited to the card holder's balance, the system retrieves card holder variables at a step 164. The retrieved card holder variables at a step 168 includes the current balance and card holder ID. The balance is adjusted by applying the rebate value at a step 172 in accordance with the formula “balance=balance−rebate”. The newly computed variable is then stored at a step 176. Stored variables 180 includes the card holders balance and card holder ID. Processing is then complete and the system stops at step 160.

It will be readily understood by those of ordinary skill in the art that the credit card rebate system and method disclosed does not preclude including additional standard features and benefits made available to credit card holders along with other credit cards. For example, the rebate credit card of the invention may include a color photo of the card holder bonded onto the credit card. The photo, in addition to helping to deter some types of fraud if the card is lost or stolen, adds a visual identification to the merchant approval process.

Many credit card issuers can replace lost or stolen credit cards, typically within 24 hours of notice. In addition, some credit card issuers may provide a service to help replace lost or stolen airline tickets, provide emergency cash up to the available credit advance limit on the credit card, and furnish information on how to replace important documents that may have also been lost or stolen.

Many credit card issuers can also keep track and alert card members of unauthorized use of a credit card by monitoring purchase patterns. When unusual charges are noticed, card holders may be called and asked to verify that authorized card users are in fact making the charges.

Additionally, many credit card issuers may offer purchaser's protection against theft, accidental damage and fire for up to, for example, 90 days from the date of purchase.

Finally, a toll-free number may be staffed with customer service representatives 365 days a year. Customer service can provide replacement cards and answer virtually any question regarding customer accounts.

All of these additional benefits can be included along with the rebate program of the invention.

It can be seen by the above description of a preferred embodiment of the system of the invention that a flexible credit card rebate program is devised wherein a rebate can be earned in accordance with purchases by a credit card holder on the issuer's credit card, which rebate is received by the card holder upon a qualifying purchase of goods or services within a category. Rebates earned are typically accrued as a percentage of eligible purchases made with the card; and the rebate received is typically the amount of rebate earned, up to a maximum rebate amount, which may generally be percentage of the purchase price of the qualifying purchase.

It will be readily understood by those of ordinary skill in the art that the system described does not need to provide for a maximum rebate as a percentage of the purchase price of the qualifying purchase. For example, a fixed maximum amount can be used, or there may be no maximum amount of rebate.

It is also readily seen that the objects of the invention are efficiently attained in the credit card rebate program described in the embodiments.

It will thus be seen that the objects set forth above, among those made apparent from the preceding description, are efficiently attained and, since certain changes may be made in carrying out the above method and in the constructions set forth for the system without departing from the spirit and scope of invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

1-38. (canceled)

39. A computerized system for implementing a credit card program rewarding use of a credit card by the credit card holder, comprising:
a credit card issued by an issuer to a holder, said credit card representing an available line of credit from said issuer for said holder and providing means for said issuer to settle one or more credit card transactions of said holder,
a data-processing computer, said computer including a database, said database storing a holder ID and a current balance associated with said holder, said current balance including a sum of all said credit card transactions and any finance or other charges minus any payments by said holder to said issuer and any refunds or other credits,
means associated with said computer for determining whether at least one of said credit card transactions made by said holder complies with a set of pre-defined program rules, said pre-defined program rules including objective criteria by which said holder is rewarded based on purchase of at least one of goods and services of any provider of a preselected class of goods or services regardless of whether there is a co-branding relationship between said issuer and said provider associated with said credit card, and regardless of whether the purchase is made using the card,
a rebate tally for said holder stored in said database, said rebate tally representing rebate credits earned by said holder based on ones of said credit card transactions that comply with said pre-defined program rules less any rebate payments paid by said issuer to said holder, said rebate tally being automatically updated in said database in response to said ones of said credit card transactions that comply with said pre-defined program rules without notice from said holder and said provider, and
a rebate payment from said issuer to said holder based on said rebate tally and being provided without affecting any point-of-sale credit card transactions of said holder, said rebate payment being unrestricted by said issuer and said provider as to use by said holder.

40. The computerized system of claim 39, wherein said rebate payment is the lesser of a portion of at least one of (i) said ones of said credit card transactions that comply with said pre-defined program rules and (ii) said rebate tally.

41. The computerized system of claim 39, wherein said one or more credit card transactions include purchase transactions, and said rebate credits are based on one of (i) a fixed percentage of the sum of all ones of said credit card purchase transactions that comply with said pre-defined program rules, and (ii) a variable percentage of the sum of all ones of said credit card purchase transactions that comply with said pre-defined program rules based on a preselected period of time.

42. The computerized system of claim 39, wherein the application of said rebate credits to said rebate payment is capped at a maximum amount incurred in a preselected period of time.

43. The computerized system of claim 39, wherein said one or more credit card transactions include purchase transactions, and said rebate payment is one of (i) a fixed amount and (ii) a percentage of said ones of said credit card purchase transactions that comply with said pre-defined program rules.

44. The computerized system of claim 39, wherein said one or more credit card transactions include at least one of cash advances made to said holder from said issuer and transfers of credit balances of said holder to said current balance, said rebate tally including at least a portion of said at least one of cash advances made to said holder from said issuer and transfers of credit balances of said holder to said current balance.

45. The computerized system of claim 39, wherein said one or more credit card transactions include purchase transactions, and said credit card purchase transactions include at least one of purchasing and leasing a particular type of goods from any manufacturer of said particular type of goods to comply with said pre-defined program rules.

46. The computerized system of claim 39, wherein said one or more credit card transactions include purchase transactions, and said credit card purchase transactions include at least one of purchasing a new car, purchasing a used car, leasing a new car and leasing a used car to comply with said pre-defined program rules.

47. The computerized system of claim 46, wherein said pre-defined program rules include requiring said holder to provide a sales receipt and a change of title of said car to said issuer.

48. The computerized system of claim 39, further comprising a second credit card issued by said issuer to a second holder to effect one or more credit card transactions, said credit card transactions of said second holder being added to said rebate tally.

49. The computerized system of claim 39, wherein said rebate from said issuer to said holder is in the form of at least one of a check forwarded to said holder from said issuer and a credit to said current balance of said holder.

50. A computerized method of providing a reward to a credit card holder for use of the credit card, comprising the steps of:
issuing a credit card from an issuer to a holder, said credit card representing an available line of credit from said issuer for said holder and providing means for said issuer to settle one or more credit card transactions of said holder,
providing a data-processing computer, said computer including a database, said database storing a holder ID and a current balance associated with said holder, said current balance including a sum of all said credit card transactions and any finance or other charges minus any payments by said holder to said issuer and any refunds or other credits,
determining using said computer whether at least one of said credit card transactions made by said holder complies with a set of pre-defined program rules, said pre-defined program rules including objective criteria by which said holder is rewarded based on purchase of at least one of goods and services of any provider of a preselected class of goods or services regardless of whether there is a co-branding relationship between said issuer and said provider associated with said credit card, and regardless of whether the purchase is made using the card,
storing in said database a rebate tally for said holder, said rebate tally representing rebate credits earned by said holder based on ones of said credit card transactions that comply with said pre-defined program rules less any rebate payments paid by said issuer to said holder, said rebate tally being automatically updated in said database in response to said ones of said credit card transactions that comply with said pre-defined program rules without notice from said holder and said provider, and
paying a rebate from said issuer to said holder based on said rebate tally without affecting any point-of-sale credit card transactions of said holder and without restriction by said issuer and said provider as to use by said holder.

51. The computerized method of claim 50, wherein said rebate is the lesser of a portion of at least one of (i) said ones of said credit card transactions that comply with said pre-defined program rules and (ii) said rebate tally.

52. The computerized method of claim 50, wherein said one or more credit card transactions include purchase transactions, and said rebate credits are based on one of (i) a fixed percentage of the sum of all ones of said credit card purchase transactions that comply with said pre-defined program rules, and (ii) a variable percentage of the sum of all ones of said credit card purchase transactions that comply with said pre-defined program rules based on a preselected period of time.

53. The computerized method of claim 50, wherein the application of said rebate credits to said rebate is capped at a maximum amount incurred in a preselected period of time.

54. The computerized method of claim 50, wherein said one or more credit card transactions include purchase transactions, and said rebate is one of (i) a fixed amount and (ii) a percentage of said ones of said credit card purchase transactions that comply with said pre-defined program rules.

55. The computerized method of claim 50, wherein said one or more credit card transactions include at least one of cash advances made to said holder from said issuer and transfers of credit balances of said holder to said current balance, said rebate tally including at least a portion of said at least one of cash advances made to said holder from said issuer and transfers of credit balances of said holder to said current balance.

56. The computerized method of claim 50, wherein said one or more credit card transactions include purchase transactions, and said credit card purchase transactions include at least one of purchasing and leasing a particular type of goods from any manufacturer of said particular type of goods to comply with said pre-defined program rules.

57. The computerized method of claim 50, wherein said one or more credit card transactions include purchase transactions, and said credit card purchase transactions include at least one of purchasing a new car, purchasing a used car, leasing a new car and leasing a used car to comply with said pre-defined program rules.

58. The computerized method of claim 57, wherein said pre-defined program rules include requiring said holder to provide a sales receipt and a change of title of said car to said issuer.

59. The computerized method of claim 50, further comprising the steps of:
issuing a second credit card to a second holder, and
storing a second rebate tally for said second holder in said database,
wherein at least a portion of said second rebate tally is added to said rebate tally.

60. The computerized method of claim 50, wherein said rebate from said issuer to said holder is in the form of at least one of a check forwarded to said holder from said issuer and a credit to said current balance of said holder.

61. A computerized method for providing a credit card rebate to a credit card holder rewarding the card holder for use of the credit card, comprising the steps of:
providing a data-processing computer including a database,
retrieving information associated with one or more purchases made by a credit card holder using a credit card issued from an issuer to said holder, said credit card representing an available line of credit from said issuer for said holder and providing means for said issuer to settle said credit card purchases of said holder,
storing said credit card purchase information in said database,
determining using said computer whether ones of said credit card purchases comply with a set of pre-defined program rules, said pre-defined program rules including objective criteria by which said holder is provided with a rebate reward based on the purchase of at least one of goods and services of any provider of a preselected class of goods or services regardless of whether there is a co-branding relationship between said issuer and said provider associated with said credit card, and regardless of whether the purchase is made using the card,
calculating a rebate reward credit for each of said ones of said credit card purchases determined to be in compliance with said pre-defined program rules, said rebate reward credit based on at least a portion of the associated one of said credit card purchases that comply with said pre-defined program rules,
maintaining a tally of rebate reward credits in said database, and
paying a rebate reward from said issuer to said holder based on at least a portion of said tally in response to at least one purchase transaction of said holder that complies with said pre-defined program rules and without intervention of said holder and said provider, said rebate reward payment not exceeding a maximum threshold amount preselected by said issuer and not affecting any point-of-sale credit card purchases of said holder.
